SEQUENCE LISTING (5 sequences)

SEQ ID NO: 1 - DNA, 18 bp, Artificial
  Synthetic DNA oligonucleotide
caagaaacacgggagcgg

SEQ ID NO: 2 - DNA, 18 bp, Artificial
  Synthetic DNA oligonucleotide
gccttgggtcggtgtttc

SEQ ID NO: 3 - DNA, 18 bp, Artificial
  Synthetic DNA oligonucleotide
gccttgggtcggtgtttc

SEQ ID NO: 4 - DNA, 18 bp, Artificial
  Peptide Nucleic Acid oligomer
ccgctcccgtgtttcttg

SEQ ID NO: 5 - DNA, 18 bp, Artificial
  Peptide Nucleic Acid oligomer
gaaacaccgacccaaggc

(19) United States
(12) Patent Application Publication
(10) Pub. No.: US 2013/0240376 A1
(43) Pub. Date: Sep. 19, 2013

(54) ELECTROCHEMICAL DETECTION OF ANALYTE

(71) Applicant: Jeppe Resen Amossen, Copenhagen (DK)

(72) Inventor: Jeppe Resen Amossen, Copenhagen (DK)

(73) Assignee: HEED DIAGNOSTICS APS, Copenhagen (DK)

(21) Appl. No.: 13/819,897

(22) PCT Filed: Sep. 2, 2011
(86) PCT No.: PCT/EP2011/065205

§ 371 Date: May 24, 2013

(30) Foreign Application Priority Data
Sep. 2, 2010 (EP) 10175057.8
Sep. 23, 2010 (JP) 10178577.2

(51) Int. Cl. G01N 27/327

(52) U.S. Cl. CPC G01N 27/327
USPC 205/777.5; 205/775

(57) ABSTRACT

Described herein is a method of detecting an analyte comprising providing a capture electrode comprising probe molecules at the surface thereof, wherein the probe molecules are designed to specifically bind to said analyte, contacting the capture electrode with a sample solution, such that said analyte in the solution forms a probe-analyte complex at the surface of said capture electrode, and measuring the electrical properties of the capture electrode after contact with said sample solution, wherein changes in said electrical properties are indicative of the formation of the probe-analyte complex at the electrode surface. The measuring is conducted in measuring solutions comprising solvents having high dielectric constants, or measuring solutions having high pH, or with electrode surfaces having been contacted with solutions comprising organic solvents.

### TECHNICAL FIELD OF THE INVENTION

The present invention relates to improved detection of analyte in a sample using complementary or near-complementary probes. In particular the present invention relates to a method for improving electrochemical detection of an analyte, such as for example nucleic acids, using capture electrodes comprising probes that are specific for said analyte, and thus form probe-analyte complexes at the electrode surface, thereby changing the electrical properties of said capture electrode, and measuring said changes, for example by measuring an electrical signal and comparing this with a reference.

### BACKGROUND OF THE INVENTION

The detection of biologically relevant molecules has numerous applications in a wide range of fields including, medicinal, forensic, diagnostic, genomic, and environmental applications. Highly sensitive and highly specific detection of small concentrations of an analyte of interest in e.g. a biological sample comprising a high diversity of molecules, some of which being very similar to the analyte, is of special interest in the above fields.

For the detection of nucleic acids (e.g. DNA or RNA) the polymerase chain reaction (PCR) is commonly used to rapidly obtain information on the genetic level. While PCR has excellent sensitivity, the technique is haunted by false positives stemming from contaminations from previous runs, by amplification bias, and by vulnerability to enzyme inhibitors and unwanted primer interactions. DNA microarrays are also being utilised, and have the advantage of being able to detect and quantify hundreds of thousands of nucleic acid sequences. However, DNA microarrays require labelling of the targets, which requires chemical modifications of the sample and is a source of errors, e.g. by incomplete labelling.

The emerging field of label-free electrochemical detection of e.g. nucleic acids is a promising alternative to existing methods (de-los-Santos-Álvarez et al., Anal Bioanal Chem (2004) 378, 104-118). The basic principle of the technique relies on a capture electrode comprising probes that are specific to the analyte of interest. The electrical properties of the capture electrode thus changes, depending on whether an analyte is bound to the probe or not, since the presence of the analyte changes the electrostatic and/or steric conditions at the electrode surface. As the detection is carried out without the need for e.g. labelling or amplification of the analytes, the workflow is greatly simplified. Furthermore, DNA microarrays utilizing this method may also be constructed wherein no labelling of the analyte is necessary.

In one promising branch of such electrochemical detection, the changes in the electrostatic and/or steric conditions at the electrode surface are detected using marker molecules. Marker molecules are redox active molecules, and they may be reduced and/or oxidized in the absence and presence of analyte at the electrode surface. Thus the presence of analyte may be shown as changes in e.g. potentials, current, capacitance and/or impedance, when reducing and/or oxidizing the marker in the absence and presence of probe-analyte complex. As an alternative to marker molecules, a semiconductive electrode material may be used, in which case the analyte can change the electrostatic conditions at the electrode surface by perturbing the energy levels of the valence and conducting bands in the electrode, thereby inducing a detectable signal (bioFET).

Furthermore, the above label-free electrochemical detection is not limited to nucleic acid detection, as any analyte may be detected as long as a probe that specifically binds to the analyte of interest can be attached to a capture electrode. Thus, one may envision the detection of e.g. a receptor or enzyme, by using a probe comprising e.g. an agonist or antagonist molecule. The basic conditions for any analyte to be detected by this method is therefore merely that it will bind to a given probe molecule, and that it will change the electrostatic conditions at the electrode surface sufficiently for it to be detected.

Furthermore, one or more capture electrodes may be incorporated into a system, where the capture electrodes are connected to electrical measuring equipment. Such a system could then be used to measure the changes in the electrical properties of the capture electrodes, in particular this may be done by comparing the electrical properties of a capture electrode with bound analyte to a capture electrode without bound analyte. The capture electrode without bound analyte may be the same as the capture electrode with bound analyte, but measured before the analyte is bound.

Several advances have already been made in this field, particularly in the field of nucleic acid detection using redox active marker molecules.

WO2010/025547 discloses bio-sensing devices and methods comprising a nano-structured microelectrode designed to generate an electrochemical signal in response to a biomolecular stimulus. In one embodiment the microelectrode comprises peptide nucleic acid (PNA) probes for detection of RNA. Arrays comprising probes are also described. A detection limit of 10 attomolar is reported. The method relies on the accumulation of positively charged Ru(III) complexes when nucleic acids hybridize at the electrode surface and appears to be optimized to its full potential. Electrochemical measurements were conducted in buffered aqueous solutions at neutral pH.

WO2009/122159 describes a biosensor device and methods comprising a capture electrode having probe molecules on the surface. In preferred embodiments the probe molecules are PNA molecules for detection of DNA. The detection method relies on the negatively charged ferri-/ferrocyanide redox active molecules (0.1 mM of each), which are repelled from the electrode surface when e.g. negatively charged DNA is bound to the probe, due to electrostatic interference. The detection sensitivity for PNA-DNA complexes is shown to increase with decreasing ionic strength of the buffer from 700 mM down to the optimum 2 mM. Electrochemical measurements were conducted in phosphate buffered aqueous solutions at neutral pH. However, the detection limit of the method used therein is femto molar, which is not yet comparable to e.g. PCR methods.

Li et al. (Anal. Chem. 2010, 82, 1166-1169) describes the interaction of certain metal ions with PNA-DNA probe-analyte complexes at electrode surfaces, when measuring impedance in the presence of [Fe(CN)₆]^{3-/4-}. It is shown that the presence of Ni²⁺ enables the detection of a single C-T mismatch in 15-mer PNA-DNA films. Electrochemical measurements were conducted in phosphate buffered aqueous solutions at pH 8.7. No detection limits are reported.

Hence, an improved method for the detection of analytes using probe molecules would be advantageous, and in particular a more sensitive method for the detection of analytes using probe molecules would be advantageous.

### SUMMARY OF THE INVENTION

Thus, an object of the present invention relates to improved methods and uses for the detection of very small amounts of analytes using capture electrodes comprising probe molecules.

In particular, it is an object of the present invention to provide methods and uses for the detection of analytes using capture electrodes comprising probe molecules that solves the above-mentioned problems of the prior art with insufficient signal-to-background ratios, which influence detection levels.

The invention is based on the surprising finding that specific variations of the physical and chemical properties of the solvents used during measurements using capture electrodes comprising probe molecules have significant impact on signal-to-background ratios. Specifically it has been found that changing the charge compensation capability of the solutions used, e.g. by adding certain non-aqueous solvents, or changing the pH of the solution, are especially effective. It is believed that the addition of these solvents and the changing of pH provides changes to the microenvironment at the electrode surface to better allow e.g. deprotonisation of acidic groups on for example a DNA analyte, which enhances the signal detected from these analytes, but other effects may also be involved. Thus, the charge compensation capability of the solutions is the unifying concept with respect to the embodiment of raising the pH and adding non-aqueous solvents with high dielectric constants.

Thus, one aspect of the invention relates to a method of detecting an analyte comprising,
providing a capture electrode comprising probe molecules at the surface thereof, wherein the probe molecules are designed to specifically bind to said analyte,
contacting the capture electrode with a sample solution, such that said analyte in the solution forms a probe-analyte complex at the surface of said capture electrode,
measuring the electrical properties of the capture electrode after contact with said sample solution, wherein changes in said electrical properties are indicative of the formation of the probe-analyte complex at the electrode surface.

Another aspect of the present invention is a method of detecting an analyte as described above wherein the measuring of the electrical properties of the capture electrode after contact with said sample solution is performed in a measuring solution having a pH value of at least pH 7.5.

Yet another aspect of the present invention is a method of detecting an analyte as described above wherein the measuring of the electrical properties of the capture electrode after contact with said sample solution is performed in a measuring solution comprising at least one non-aqueous solvent having a dielectric constant higher than 80 at 30° C.

Another aspect of the present invention is a method of detecting an analyte as described above wherein the capture electrode is contacted with a solution comprising least one organic solvent prior to the measuring of the electrical properties of the capture electrode.

Yet another aspect of the present invention is the use of a measuring solution having a pH higher than 7.5 for increasing the signal-to-background ratio in detection of an analyte, said detection comprising measuring the electrical properties of a capture electrode comprising probe molecules at the surface thereof, wherein changes in said electrical properties are indicative of the formation of a probe-analyte complex.

Another aspect of the present invention relates to the use of measuring solution comprising at least one non-aqueous solvent having a dielectric constant higher than 80 at 30° C. for increasing the signal-to-background ratio in detection of an analyte, said detection comprising measuring the electrical properties of a capture electrode comprising probe molecules at the surface thereof, wherein changes in said electrical properties are indicative of the formation of a probe-analyte complex.

A final aspect of the present invention is the use of solution comprising at least one organic solvent for increasing the signal-to-background ratio in detection of an analyte, said detection comprising measuring the electrical properties of a capture electrode comprising probe molecules at the surface thereof, wherein changes in said electrical properties are indicative of the formation of a probe-analyte complex.

### BRIEF DESCRIPTION OF THE FIGURES

FIG. 1 shows an example of the mechanism of detection for one embodiment of present invention, wherein DNA is detected using a PNA probe and ferri/ferrocyanide as redox active marker molecules using a gold electrode.

FIG. 2A-2C shows cyclic voltammograms (CVs) and differential pulse voltammograms (DPVs) recorded with various contents in (v/v) of N-methyl acetamide (NMAA). Top; CVs recorded with and without S-DNA 3599 present on the electrode in the presence of increasing contents (0% (FIG. 2A), 50% (FIG. 2B) and 90% (FIG. 2C)) of NMAA in the measuring solution. Bottom; DPVs recorded with and without S-DNA 3599 present on the electrode in the presence of increasing contents (0% (FIG. 2A), 50% (FIG. 2B) and 90% (FIG. 2C)) of NMAA in the measuring solution. CVs displayed are second scans starting from open circuit potential (NMAA content low to high: 200, 10, and −137 mV) and scanning in the positive direction. The data was recorded with 200 μM K₃Fe(CN)₆, 200 μM K₄Fe(CN)₆ and 5 mM PB at pH 8.0.

FIG. 3A-3C shows CVs (top) and DPVs (bottom) recorded with 200 μM K₃Fe(CN)₆ and 200 μM K₄Fe(CN)₆ at pH 7.0 (FIG. 3A), 8.0 (FIG. 3B), and 9.0 (FIG. 3C) with and without S-DNA 3599 probe present on the electrode. The buffer used was 5 mM PB at pH 7.0 and 8.0 and 5 mM Tris-HCl at pH 9.0. The CV data shown are second scans started at 190 mV scanning in the positive direction.

FIG. 4A-4B shows CVs (top) and DPVs (bottom) recorded with a capture electrode comprising the PNA 3598 probe (FIG. 4A) and a capture electrode comprising the PNA 3599 probe (FIG. 4B) before and after incubation with 500 nM DNA complementary to PNA 3598. The data are recorded in 5 μM Ru(NH₃)₆Cl₃ with 1 mM K₃Fe(CN)₆ and 1 mM Tris-HCl buffer pH 8.4. The voltammograms are second scans started from 0 going negative.

### DETAILED DESCRIPTION OF THE INVENTION

### Definitions

Prior to discussing the present invention in further details, the following terms and conventions will be defined:

An “analyte” in the present context is any molecule or species susceptible to detection via binding to a probe molecule on the surface of a detection device such as a capture electrode, thus selectively forming a probe-analyte complex, while other molecules or species present will not bind, or will bind to a much lesser extent to the probe molecule. Examples of analytes include DNA, RNA, PNA, LNA, small molecules, inorganic complexes, enzymes, peptides and proteins. Also, analyte may refer to a combination of a sought species in a complex with a different labelling substance, thus allowing for detection of species not capable of inducing a signal by itself. The complex may be formed prior to, during or after binding to the probe.

A “capture electrode” within the context of the present invention is in the broadest sense the part of a detection device which features probe molecules on its surface, which bind to the analyte. The capture electrode is capable of relaying the signals that are measured before and after formation of a probe-analyte complex on its surface. Examples of capture electrodes are modified gold electrodes, nanostructured electrodes, and semiconducting materials, e.g. biological Field Effect Transistors (bioFET). The electrical signal may be relayed to any means for measuring an electrical signal.

A “reference capture electrode” is herein defined as an electrode not comprising any probe molecules. The reference capture electrode may otherwise be similar to the capture electrode, so as to provide the best possible reference or background signal. It may for example comprise the linker and spacer molecules of the capture electrode, but not the probe molecules. It is not to be confused with a standard reference electrode, which provides a reference potential.

A “probe molecule” is a molecule featured on the surface of a capture electrode, which is capable of binding to a specific analyte or small number of analytes, which the user is aiming to detect the presence of. The probe molecule is irreversibly attached or immobilised to the capture electrode under the conditions used in the present method. Attachment may be achieved via a linker molecule. Examples of probe molecules include DNA, RNA, PNA, LNA, morpholino antisense oligos, small molecules, peptides and proteins.

In the present invention a number of solutions may be used. A “sample solution” is a solution comprising the analyte of interest, typically along with a range of other molecules and species. A “measuring solution” is the solution wherein the measuring of the electrical properties of the capture electrode is conducted to detect the presence of a probe-analyte complex. A “washing solution” is in the present context a solution designed to reduce the amount of non-specific molecules at the capture electrode surface, while maintaining any probe-analyte complexes present. This is in contrast to a “cleaning solution” designed to remove everything but attached and/or immobilised molecules. Finally a “reference solution” may be used, which is a solution wherein the electrical properties of the capture electrode having no probe-analyte complex are measured. Some of these solutions may in some embodiments be one and the same, e.g. in some embodiments the reference solution and the measuring solution are the same solution. All the solutions may be incorporated in a flow system that controls which solution is contacted with the electrode, i.e. the capture electrode is positioned in a flow chamber where separate liquids may be passed through.

A “probe-analyte complex” is the species formed when the probe and the analyte(s) have bound to each other. The binding is selective and may be provided via any of the binding forces known to the skilled person, and may also include for example selective covalent binding, but is typically non-covalent binding. A number of useful probe-analyte complexes may be envisioned such as for example PNA-DNA, PNA-RNA, morpholino-DNA, morpholino-RNA hybrids, small molecule-protein complexes, peptide-protein complexes and any other feasible combinations of probes and analytes.

The “electrical properties” of the capture electrode is in the broadest sense any property that may be changed by the formation of a probe-analyte complex and/or the presence of analyte near the surface of the capture electrode. The electrical properties must be detectable via a signal the capture electrode is able to relay. For example, an electrical property may be the charge distribution at the surface of the capture electrode, the steric bulk at the surface of the capture electrode, the presence of channels at the surface of the capture electrode or the energies of the conduction bands of the capture electrode, where the latter refers to BioFET applications. These are all properties that may change on formation of a probe-analyte complex.

The “signal-to-background ratio” is to be understood as the ratio between the signal recorded in the presence of a probe-analyte complex at the surface of the capture electrode and the corresponding signal when no probe-analyte complex is present at the capture electrode surface, i.e. the ratio between the sample signal and the background signal. The background signal may be measured on the same capture electrode as the sample signal or on another electrode.

The Method

The first aspect of the present invention is a method of detecting an analyte comprising,
providing a capture electrode comprising probe molecules at the surface thereof, wherein the probe molecules are designed to specifically bind to said analyte,
contacting the capture electrode with a sample solution, such that said analyte in the solution forms a probe-analyte complex at the surface of said capture electrode,
measuring the electrical properties of the capture electrode after contact with said sample solution, wherein changes in said electrical properties are indicative of the formation of the probe-analyte complex at the electrode surface.

The inventors have surprisingly found that the above method is particularly sensitive to changes in solution conditions, while measuring the electrical properties of the capture electrode. Without being bound to theory it is believed that the signal is usually limited by spatial extent of the electrostatic fields from uncompensated charge of the analyte. It is believed that minimizing the charge compensation capability of the measurement solution significantly improves the signal-to-background ratio, and this may be achieved by a number of approaches. One method known in literature, which may work in a similar fashion, is the reduction of the ionic strength of the solution to a certain beneficial value. The two means described herein, increasing pH of the measurement solution and adding a solvent to the measurement solution having a higher dielectric constant than water, may utilise different means to achieve the same effect, and may thus improve the signal-to-background ratio using a common mechanism.

In a preferred embodiment the changes in electrical properties are indicated as a ratio between a reference signal and the signal measured after contact with the sample solution.

The reference signal may be the electrical properties as measured in a reference solution or with a reference capture electrode. The “reference capture electrode” or reference electrode may preferably be an electrode not comprising any probe molecules. A reference electrode may or may not comprise linker and/or spacer molecules.

Particularly changes in the charge compensation capability of the solutions used may enhance signal-to-background ratio significantly, such as by adding high dielectric constant solvents or raising the pH of the solution. These aspects of the invention are described in the sections below.

Measuring with Addition of Solvents Having High Dielectric Constants

In one useful embodiment of the present invention a method as described above is provided wherein the measuring of the electrical properties of the capture electrode after contact with said sample solution is performed in a measuring solution comprising at least one non-aqueous solvent having a dielectric constant higher than 80 at 30° C.

By “non-aqueous solvent” is meant any chemical substance different from water. Some substances that are not traditionally regarded as solvents may be included, such as substances that are not liquid at room temperature. A solution comprising at least one non-aqueous solvent may still also comprise water.

The “dielectric constant” also referred to as the relative permittivity or ∈ᵣ is in chemistry a measure of the polarity and/or polarizability of e.g. a solvent. The dielectric constant varies with temperature, and is thus always defined in conjunction with a temperature for any given substance. For example at 20° C. the dielectric constant of water is 80.1, while that of n-hexane is 1.89. For an extensive listing of dielectric constants for various substances see Chemical Rubber Company Handbook of Physics and Chemistry.

The addition of non-aqueous solvents having a higher dielectric constant than 80 at 30° C. surprisingly has a positive impact on detection levels of various analytes when implemented in the present method. Without being bound to theory it is, as described above, believed that the signal is usually limited by the presence of uncompensated charge of the analyte. Increasing the dielectric constant of the solution favours the presence of free charges, thus reducing the compensation of charge. The effect is a much more efficient extinction of signal due to analyte presence.

Addition of a non-aqueous solvent with even higher dielectric constants than 80 at 30° C. may also have a further positive effect in some embodiments. Thus, said non-aqueous solvent may have a dielectric constant higher than 90 at 30° C., such as higher than 100, 110, 120, 130, 140, 150, 160, such as higher than 170 at 30° C. Preferably the non-aqueous solvent has a dielectric constant in the range of 80-280, such as in the range of 100-260, 120-240, 140-220, 150-200, such as in the range of 160-190 at 30° C. As water is typically present in the measuring solution, at least in the prior art, another embodiment is a method wherein the non-aqueous solvent has a dielectric constant higher than that of water at 30° C.

The non-aqueous solvents as described above may be selected from the group consisting of N-methylformamide (∈ᵣ=173 at 30° C.), N-methylacetamide (∈ᵣ=179 at 30° C.), N-methylpropanamide (∈ᵣ=170 at 20° C.), N-ethylacetamide (∈ᵣ=125 at 30° C.) and N-propylpropanamide (∈ᵣ=113 at 30° C.) or mixtures thereof. For example the solvent may be N-methylacetamide.

The amount or percentage (v/v) of the at least one non-aqueous solvent may advantageously be high to obtain the highest impact on the detection levels. Thus, the amount of said non-aqueous solvent is at least 10% (v/v), such as at least 20%, 30%, 40%, 50%, 60%, 70%, 75%, 80%, 85% (v/v), such as at least 90% (v/v). Preferably the amount of said non-aqueous solvent is in the range of 10-100% (v/v), such as in the range of 20-100%, 30-100%, 40-100%, 50-100%, 60-100%, 70-100% (v/v), 80-100% (v/v) such as in the range of 85-99.9% (v/v).

Measuring at Higher pH

Changes in pH also affect the charge compensation ability of the solution. It has surprisingly been found that raising the pH to above physiological pH (i.e. above pH 7.4) increases the signal-to-background ratio in the present method.

Thus a preferred embodiment of the present invention is a method as described above wherein the measuring of the electrical properties of the capture electrode after contact with said sample solution is performed in a measuring solution having a pH value of at least pH 7.5.

For example the measuring solution may have a pH value of at least pH 7.8, such as at least pH 8.0, 8.2, 8.4, 8.6, 8.8, 9.0, 9.2, 9.4, 9.6, 9.8, 10.0, 10.2, 10.4, 10.6, 10.8, 11.0, 11.2, 11.4, 11.6, 11.8 such as at least pH 12.0. One useful method is a method wherein said measuring solution has a pH value of at least pH 8.8. Also the measuring solution may have a pH value in the range of pH 7.8-13.0, such as in the range of pH 8.0-12.8, 8.2-12.6, 8.4-12.4, such as pH 8.6-12.2. Alternatively the pH may be in the range of pH 8.6-12.0, 8.7-11.5, such as pH 9.0-11.0, or in the range of pH 7.5-13.0, 7.5-12.5, 7.5-11.5, 7.5-11.0, such as pH 7.5-10.5, or in the range of pH 8.0-13.0, 8.0-12.5, 8.0-11.5, 8.0-11.0, such as pH 8.0-10.5, or in the range of pH 8.8-13.0, 8.8-12.5, 8.8-11.5, 8.8-11.0, such as pH 8.8-10.5, or in the range of pH 9.0-13.0, 9.0-12.5, 9.0-11.5, 9.0-11.0, such as pH 9.0-10.5 or in the range of pH 9.2-13.0, 9.2-12.5, 9.2-11.5, 9.2-11.0, such as pH 9.2-10.5.

Measuring after Contact with Organic Solvents

Contacting the capture electrode comprising probe molecules with a solution comprising at least one organic solvent prior to the measuring of electrical properties of said capture electrode has also been found to have significant impact on signal-to-background ratios.

Thus in one useful embodiment of the present invention a method as described above is provided, wherein the capture electrode is contacted with a solution comprising least one organic solvent prior to the measuring of the electrical properties of the capture electrode.

In one embodiment the solution comprising at least one organic solvent is the sample solution, but it may also be a washing solution applied after the sample solution and prior to the measuring solution. Without being bound by theory, it is believed that the presence of organic solvents during or after formation of probe-analyte complexes helps to reduce the formation of non-specific probe-impurity complexes, which may for example form mainly due to hydrophobic interactions.

The presence of organic solvents may help reduce the significance of such hydrophobic interactions as compared to more specific probe-analyte interactions, while surprisingly not disturbing and/or reducing the latter interactions.

It has been found that combining organic solvents may have further beneficial effects, thus in further embodiments the above described solution comprises at least 2 different organic solvents. The solution comprising at least one organic solvent may further comprise water, detergents and/or electrolytes.

Although any organic solvent may be envisaged in the present method, the organic solvent may be selected from the group consisting of formamide, dimethylsulfoxide (DMSO), dimethylformamide (DMF), tetrahydrofurane (THF), acetonitrile, N-methylformamide, N-methylacetamide, N-methylpropanamide, N-ethylacetamide and N-propylpropanamide, ethers including dimethyl ether and diethyl ether, alkanes including pentane, hexane, heptane and octane, and/or alkyl alcohols including propanol, ethanol and methanol, and any combinations thereof. Specifically the organic solvents may be selected from tetrahydrofurane (THF), acetonitrile, and ethanol or combinations thereof.

Further Embodiments of the Method and Measuring Solution

The solutions used in the present method as described above are a central part of the invention, and therefore these are described in further detail below with emphasis on the measuring solution.

Firstly, it is noted that the measuring solution may in a useful embodiment be equal to the sample solution, optionally with added buffer and/or solvent having a dielectric constant higher than 80 at 30° C. However, in a preferred embodiment the measuring solution is separate from the sample solution, so that e.g. the capture electrode is contacted with the sample solution and subsequently transferred to the measuring solution. The amount of time the capture electrode is contacted with the sample solution may vary, but may be from 1-90, 1-80, 1-70, 1-60 minutes such as from 10-90, 10-80, 10-70, 10-60 minutes.

In one embodiment the pH of the measuring solution is controlled by addition of a buffer. The buffer may be any buffer known to the skilled person, but may be one or more selected from the group consisting of acetate, carbonate, bicarbonate, phosphate, tris, tricine, trizma, bicine, glycine, N-(2-hydroxyethyl)piperazine-N′-(4-butane sulfonic acid) (HEPBS), N-tris(hydroxymethyl)methyl-4-aminobutane sulfonic acid (TABS), N-(1,1-dimethyl-2-hydroxyethyl)-3-amino-2-hydroxypropane sulfonic acid (AMPSO), 2-(cyclohexylamino)ethane sulfonic acid (CHES), 3-(cyclohexylamino)-2-hydroxy-1-propane sulfonic acid (CAPSO), (beta)-aminoisobutyl alcohol (AMP), 3-(cyclohexylamino)-1-propane sulfonic acid (CAPS), 4-(cyclohexylamino)-1-butane sulfonic acid (CABS), Bis-Tris Propane, hydrogen orthophosphate, tetraborate, or combinations thereof. When the buffer has an overall negative charge the counter ion may be one or more alkali metal or alkaline earth metal ions. The alkali metal ions may preferably be selected from the group consisting of one or more of lithium, sodium and potassium ions.

The concentration of said buffer may vary according to for example how much non-aqueous solvent is present in the measuring solution, and to what pH preferred, thus it may be in the range of 0.001-1000 mM, such as 0.010-800, 0.050-700, 0.100-500, 0.200-400, 0.300-200, 0.400-100, 0.500-50, 0.700-40, 0.800-30 mM, 0.900-20 mM such as 1-10 mM.

The electrical properties of the capture electrode comprising probe molecules may be measured using redox active molecules. Thus in one useful embodiment of the present method the measuring solution comprises one or more redox active molecules in solution.

A “redox active molecule” also referred to as a “marker” in the present context is any molecule or molecular complex capable of being oxidized and/or reduced, for example via electrochemical methods. Typically the redox active molecule is oxidized or reduced at the capture electrode surface, for example due to an applied potential, and thus changes in the electrical properties of the capture electrode will influence the oxidation/reduction of the redox active molecules, e.g. the rate of oxidation/reduction. It follows that said influence on the on the oxidation/reduction of the redox active molecules may constitute the signal measured which relays the above-mentioned changes in electrical properties in this particular embodiment.

The redox active molecules are preferably salts of metal complexes. The metal complexes may advantageously be selected from the group consisting of [Fe(CN)₆]³⁻, [Fe(CN)₆]⁴⁻, [Ru(CN)₆]³⁻, [Ru(CN)₆]⁴⁻, [Mn(CN)₆]³⁻, [Mn(CN)₆]⁴⁻, [W(CN)₈]³⁻, [W(CN)₈]⁴⁻, [Os(CN)₆]³⁻, [Os(CN)₆]⁴⁻, [Mo(CN)₈]³⁻, [Mo(CN)₈]⁴⁻, [Cr(CN)₆]³⁻, [Co(CN)₆]³⁻, [PtCl₆]²⁻, [SbCl₆]³⁻, [RhCl₆]³⁻ and [IrCl₆]²⁻. Especially preferred is a method wherein the redox active molecules are salts of [Fe(CN)₆]³⁻, [Fe(CN)₆]⁴⁻ or a combination thereof. The counter ion(s) forming the salt may be any ion(s) of the opposite charge. The salts must be at least sparingly soluble in the measuring solution. Preferably, when the metal complex has an overall negative charge the counter ion is one or more alkali metal or alkaline earth metal ions. The alkali metal ions may preferably be selected from the group consisting of one or more of lithium, sodium and potassium ions.

The optimum concentration of the one or more redox active molecules may vary according to the other parameters selected for the measuring solution. A preferred embodiment is a method wherein the combined concentration of redox active molecules in the measuring solution is in the range of 0.001-100.00 mM, such as in the range of 0.01-50.00, 0.02-20.00, 0.03-10.00, 0.04-5.00 mM, 0.06-2.00 mM, 0.08-1.00 mM, such as in the range of 0.10-0.80 mM.

The measuring solution may advantageously comprise two redox active molecules, and the ratio between them may be in the range of 1:100-100:1, such as 1:50-50:1, 1:20-20:1, such as 1:10-10:1. The two redox active molecules may be [Fe(CN)₆]⁴⁻ and [Fe(CN)₆]³⁻ where the ratio between them may be in the range of 2:1-1:20, such as 1:1-1:18, 1:1-1:15, 1:1-1:12, such as 1:1-1:10.

Other means of creating a signal relaying the changes in electrical properties of the capture electrode may also be applied. One embodiment is the case, where the capture electrode is a semiconducting material, which may form the channel in a biological Field Effect Transistor (bioFET). In such case the presence of uncompensated charges on the surface will perturb the energy levels of the valence and conducting bands in the semiconducting material, thus altering the resistivity of the semiconducting material. In such case, the charged current carriers is present as holes or electrons in the semiconducting material, thus providing the same function as the redox active molecules in the measuring solution. Without being bound to theory, electrostatic forces may act between the analyte and the current carriers in the semiconducting material corresponding to the interaction between the analyte and the redox active molecules in solution. Measurements may be carried out between elements present on each side of the current carriers, which in the bioFET case are the source and drain, whereas in the redox active molecules case are the metal on the working electrode and the counter electrode. In the case of bioFET, the described method will thus similarly increase the signal-to-background ratio.

The overall ionic strength of the measuring solution influences the detection levels of the present method as well. Thus, in a preferred embodiment the measuring solution has an ionic strength in the range of 0.010-100 mM, such as in the range of 0.05-90 mM, 0.10-70 mM, 0.20-50 mM, 0.40-40 mM, 0.80-20 mM, such as 1.00-10 mM.

As is understood from the above, the changes in electrical properties of the capture electrode may be measured in a number of ways. Accordingly, the baseline or reference with which the electrical properties of the capture electrode comprising any probe-analyte complex is compared, may also be recorded in different ways.

Thus, in a preferred embodiment of the present method prior to contacting the capture electrode with a sample solution a further step is provided comprising,
measuring the electrical properties of the capture electrode in a reference solution, said reference solution not comprising any analyte.

The reference solution as described above may also be the measuring solution, i.e. the reference measurement is made in a reference solution and the capture electrode is contacted with the sample solution, and optionally washing solutions where after the electrical properties of the capture electrode are measured in the reference solution again, the reference solution thus effectively being equal to the measuring solution.

Alternatively, the changes in electrical properties of the capture electrode may be defined as the electrical properties of the capture electrode after contact with a sample solution as compared with the electrical properties of a reference capture electrode not comprising any probe molecules. The reference capture electrode may optionally go through the exact same steps as the capture electrode. The reference capture electrode is not to be confused with a reference electrode in the traditional sense, the latter being employed to define a reference potential.

The changes in electrical properties are typically indicated as a ratio between a reference signal (e.g. electrical properties as measured in the reference solution or with the reference capture electrode) and the signal measured after contact with the sample solution (e.g. electrical properties as measured in the measuring solution using the capture electrode).

The Capture Electrode, Probes and Analytes

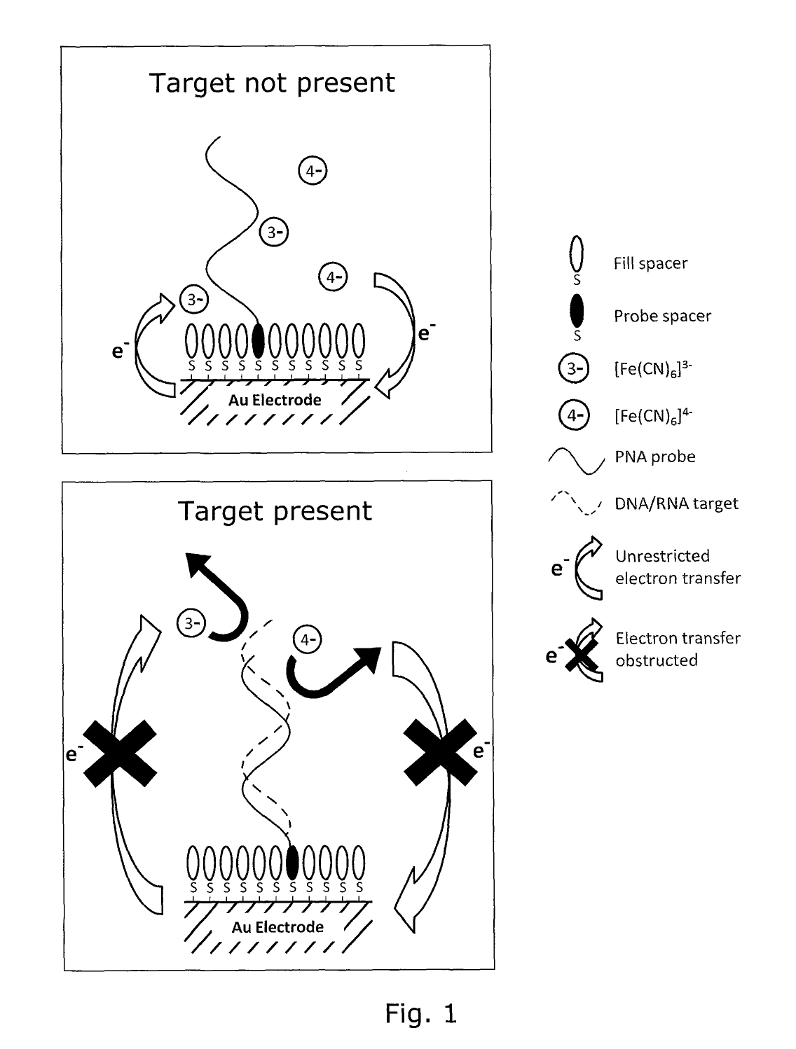

The basic working principle of the capture electrode comprising probe molecules is depicted for one embodiment in FIG. 1. As mentioned in the definition of electrical properties, these may represent different physical/chemical phenomena. Thus, in preferred embodiments the changes in the electrical properties of the capture electrode are indicative of changes of the charge and/or charge distribution and/or steric bulk and/or presence of molecular scale channels at the capture electrode surface due to probe-analyte complex formation.

Due to the nature of the above phenomena, the present method is especially advantageous when the probe molecules are electrically un-charged and the analyte is charged. For example, when using marker molecules that have charge, the change in electrical properties towards these marker molecules is especially enhanced when the charge of the probe-analyte complex has the same sign as the marker (i.e. they are both negative or positively charged), thus repelling the marker away from the capture electrode, whereas the probe molecule alone preferably being uncharged, does not repel the marker molecules.

The probe molecule may be any molecule or species capable of forming a complex with an analyte. A method is however preferred, wherein the probe molecules are selected from the group consisting of small molecules, proteins, peptides, nucleic acids and nucleic acid analogues. The probe molecules may advantageously be selected from nucleic acids and/or derivations and/or analogues thereof, such as de-oxy ribonucleic acids (DNA), ribonucleic acids (RNA), peptide nucleic acids (PNA), Morpholino antisense oligos (morpholino), glucol nucleic acids (GNA) and locked nucleic acids (LNA). The nucleic acids, derivations or analogues thereof used in a probe may comprise any number of nucleotide or nucleotide analogue monomers. Preferred numbers of monomers are 1-10.000, such as 1-5.000, 1-1.000, 1-500, 1-200, 1-100, 1-50, 1-20, or such as 2-10.000, 3-5.000, 4-1.000, 5-500, 5-200, 5-100, such as preferably 5-50 monomer units.

The analyte may accordingly be any molecule or species capable of forming a complex with a probe molecule. A method is however preferred where the analytes are selected from nucleic acids and/or derivations and/or analogues thereof, including de-oxy ribonucleic acids (DNA), ribonucleic acids (RNA), peptide nucleic acids (PNA), glucol nucleic acids (GNA) and locked nucleic acids (LNA), and also small molecules, proteins including enzymes and peptides and any covalently bound combinations of the above.

Thus, an especially useful embodiment of the present invention is one wherein the probe-analyte complex at the electrode surface is a hybridized pair of nucleic acids, nucleic acid analogues or combinations thereof. The probe may preferably be a peptide nucleic acid (PNA) or Morpholino antisense oligos (morpholino). PNAs and morpholinos are uncharged, and the analyte may preferably be charged. Thus the analyte may preferably be a de-oxy ribonucleic acid (DNA) or ribonucleic acid (RNA). In a preferred embodiment the probe is a peptide nucleic acid (PNA) and the analyte is a de-oxy ribonucleic acid (DNA) or ribonucleic acids (RNA).

The probe molecules are preferably attached to the surface of the capture electrode via linker molecules. Also the capture electrode may further comprise spacer molecules at the surface thereof. The spacer molecules may be linker molecules not comprising any probe molecules. The probe molecules and spacer molecules may preferably form a mixed monolayer at the surface of the capture electrode. This mixed monolayer may be produced by simultaneously co-immobilising probe molecules and spacer molecules onto the surface of the capture electrode or by sequential immobilisation. The ratio of probe molecules to spacer molecules may be any value from 0.01% to 100% probe molecules, but can in specific cases be optimized to a value between 5% and 10% (see S. D. Kieghley et al., Biosensors & Bioelectronics 2008, 24 (4), 906-911). Useful linker molecules include any molecule capable of connecting probe molecules with the surface of the capture electrode, such as alkanes, alkenes, alkynes, alcohols, thiols, organic acids, ethers, esters, disulphides, thioesters, amines, amides, amino acids, nucleotides, polymers, sugars, ionic complexes, peptides, and proteins. Linker molecules may also comprise combinations of two or more connected linker molecules, and the linker molecules may be connected before, during or after immobilisation or co-immobilisation of probes. Particularly useful linker groups include alkyl thiols (HS—(CH₂)ₙ—), short poly ethylene glycols connected to thiols, or short polyethylene glycols connected to cysteine. Useful spacer molecules include the before mentioned linker molecules (with no probe attached) and may advantageously be selected from molecules inherently able to form self-assembled monolayers or monolayers, such as alkyl thiols, alkyl thiols with functionalised end groups, silanes, and silanes with functionalised end groups.

Alternatively, the immobilization can also be done through various other strategies, such as incorporation in a polymer, through a biotin-avidin linker or through hybridization to previously immobilised complementary nucleotides or analogues.

The material used as the basis for the capture electrode is preferably a conducting or semiconducting material, and may be selected from the group consisting of gold (Au), platinum (Pt), palladium (Pd), wolfram (W), carbon (C), silicon (Si), gallium (Ga), arsenic (As), aluminium (Al), germanium (Ge), tin (Sn), indium (In), ceramics, plastics, conducting polymers or combinations thereof. Specifically, the electrodes may be selected from gold (Au) and palladium (Pd). An especially useful material is gold (Au). Linker and spacer molecules comprising —SH groups are especially advantageous in connection with gold electrodes, as they will readily attach to a gold surface via the sulfur atom.

The signal relayed by the capture electrode, which indicates the electrical properties, may vary according to the detection method chosen. When electrochemical methods are employed the changes in the electrical properties of the capture electrode indicative of the formation of the probe-analyte complex at the electrode surface may be measured as changes in impedance, current or potential. These properties may be measured using a means for measuring electrical signals and using various techniques known to the skilled person, and thus the changes in the electrical properties of the capture electrode are preferably measured using electrochemical methods selected from the group consisting of electrochemical impedance spectroscopy (EIS), cyclic voltammetry (CV), differential pulse voltammetry (DPV) and square wave voltammetry (SWV). In some embodiments other electrical measurement techniques may be used, such as voltammetry or determination of impedance or resistance.

The signal relayed by the capture electrode which indicates the electrical properties may be measured by incorporating the capture electrodes into a system, where the capture electrodes may be connected to means of measuring electrical signals i.e. electrical measuring equipment. Such a system may then be used to measure the changes in the electrical properties of the capture electrodes.

The electrical measuring equipment may be any system designed for measuring an electrical signal.

The capture electrode may be part of an array or biochip comprising a plurality of capture electrodes, such as 2 or more capture electrodes, 5 or more, 10 or more, 20 or more, 50 or more, or 100 or more capture electrodes. The method described herein may advantageously be applied where the capture electrode comprising probe molecules at the surface thereof functions as a sensor applied in an array of a plurality of sensors, such as 2 or more sensors. Thus in a preferred method each sensor comprising a capture electrode having probe molecules at the surface thereof is individually addressable and each sensor can be applied for the detection of a specific analyte. In this application the probe molecules will typically vary between each capture electrode in the array. The array may preferably be designed for the detection and/or identification of bacteria, fungi, viruses and/or archea.

Use and Applications

A further aspect of the present invention is the use of a measuring solution comprising at least one non-aqueous solvent having a dielectric constant higher than 80 at 30° C. for increasing the signal-to-background ratio in detection of an analyte, said detection comprising measuring the electrical properties of a capture electrode comprising probe molecules at the surface thereof, wherein changes in said electrical properties are indicative of the formation of a probe-analyte complex.

Yet another aspect of the present invention is the use of a measuring solution having a pH higher than 7.5 for increasing the signal-to-background ratio in detection of an analyte, said detection comprising measuring the electrical properties of a capture electrode comprising probe molecules at the surface thereof, wherein changes in said electrical properties are indicative of the formation of a probe-analyte complex.

One other aspect of the present invention is the use of a solution comprising at least one organic solvent for increasing the signal-to-noise ratio in detection of an analyte, said detection comprising measuring the electrical properties of a capture electrode comprising probe molecules at the surface thereof, wherein changes in said electrical properties are indicative of the formation of a probe-analyte complex.

In the above use aspects the “signal-to-background ratio” is to be understood as the ratio between the signal recorded in the presence of a probe-analyte complex at the surface of the capture electrode and the corresponding signal when no probe-analyte complex is present at the capture electrode surface, i.e. the ratio between the sample signal and the background signal. The background signal may be measured on the same capture electrode as the sample signal or on another electrode, such as a reference capture electrode.

It should be noted that embodiments and features described in the context of one of the aspects of the present invention also apply to the other aspects of the invention. Thus the embodiments applying to the herein described method also applies to the described uses and vice versa.

All patent and non-patent references cited in the present application, are hereby incorporated by reference in their entirety.

The invention will now be described in further details in the following non-limiting examples.

### EXAMPLES

### Materials and Methods

Experiments were conducted using one of two corresponding setups with insignificant differences in sets of instrumentation and material. Both sets are listed below, denoted with either (S1) or (S2). In each example, the used setup is specified.

Instrumentation
Autolab: PGSTAT10: GPES ver 4.9 with FRA2 module NOVA 1.5 (S1) or Autolab PGSTAT128N: NOVA 1.7 (S2). Example 6 uses Autolab PGSTAT302N: NOVA 1.6
Sonicator: Branson 1200, 30W 47 kHz output (S1) or Brandelin Sonorex RK31, 60W 35 kHz output (S2).
Spectrophotometer: Nanodrop ND 1000
Ultra pure water (18.2 M cm) (mQ): Purelab ultra, ELGA (S1) or Milli-Q Reference system from Millipore (S2)

Materials
Polishing cloths from Struers (S1)
Alumina slurry (paste): 100 nm (40700036) Struers (S1)
Silica suspension: 50 nm (40700002) Struers (S1)
Eppendorf non-stick: Axygen 2.0 ml, Maxymum recovery, clear: MCT-200-L-C(S1) or SafeSeal Microcentrifuge Tubes 1.7 ml, cat#11720 from Sorenson BioScience, Inc. (S2)
Electrodes: planar gold electrodes 1.6 mm in diameter. From BASi, MF-2014 (S1) or from BioLogic, A-002314 (S2)
Reference electrode: Ag/AgCl, saturated KCl, CHI128 from CH Instruments (51) or Ag/AgCl, 1M KCl, CHI111 from CH Instruments (S2)

Chemicals and their Abbreviations

The chemicals used were of analytical grade and used as received. The following are specified:
Hexaammineruthenium(III) chloride, Ru(NH₃)₆Cl₃, 262005 from Sigma-Aldrich, 98% (S1)
Potassium ferricyanide (potassium hexacyanoferrate(III), K₃Fe(CN)₆), Merck, art. No. 4973, Pro analysi (S1) or 455946 from Sigma-Aldrich (S2)
Potassium ferrocyanide (potassium hexacyanoferrate(II), K₄Fe(CN)₆), Sigma-Aldrich 31254, >99% (S1) or 455989 from Sigma-Aldrich (S2)
N-methylacetamide (NMAA), M26305 from Sigma-Aldrich (S1) and (S2)
6-Mercaptohexan-1-ol (MCH), Fluka 63762, >97% (GC) (S1) or 725226 from Sigma-Aldrich (S2)
Argon, Air Liquide Alphagaz 1 Argon (S1) or Air Liquide Alphagaz 2 Argon, (S2)
Phosphate buffer (PB); potassium phosphate: 60211 from Sigma-Aldrich (S1)
3-(Cyclohexylamino)-2-hydroxy-1-propanesulfonic acid (CAPSO) C2278 from Sigma-Aldrich (S2)
Tris, Trizma base, T1503 from Sigma-Aldrich (S1) and (S2)
Ethylenediaminetetraacetic acid (EDTA), 39692 from Sigma-Aldrich (S1)
Sodium Chloride, NaCl, S5886 from Sigma-Aldrich (S1) and (S2)
Hydrochloric Acid, HCl, H1758 from Sigma-Aldrich (S1) and (S2)
Potassium Hydroxide, KOH, 60370 from Sigma-Aldrich (S1) and (S2)
Nitric acid, HNO₃ (70%), 30702 from Sigma-Aldrich (S1) and (S2)

Probes and Oligonucleotides

Probes and oligonucleotides are the same in setups (S1) and (S2). The sequences and physical data of the utilized probes and oligonucleotide analytes are listed in table 1 below. The oligonucleotides were purchased from TAG Copenhagen (tagc.com) whereas the PNA probes were synthesized using the technique described in Peptide Nucleic Acids, (Editor: Peter E. Nielsen), Horizon Bioscience, 2^{nd} edition 2004.

TABLE 1
Sequences of probes and oligonucleotides analytes

| | SEQ | | Mass |
|---|---|---|---|
| Oligo | ID NO | Sequence | (g/mol) |
| DNA 3598 | 1 | 5′dCAA-GAA-ACA-CGG-GAG-CGG-3′ | 5.592 |
| DNA 3599 | 2 | 5′dGCC-TTG-GGT-CGG-TGT-TTC-3′ | 5.529 |
| S-DNA 3599 | 3 | HS-(CH₂)₆-5′dGCC-TTG-GGT-CGG-TGT-TTC-3′ | 5.472 |
| PNA 3598 | 4 | Ac-cys-(eg₂)₂-CCG-CTC-CCG-TGT-TTC-TTG-Lys-NH₂ | 5.455 |
| PNA 3599 | 5 | Ac-cys-(eg₂)₂-GAA-ACA-CCG-ACC-CAA-GGC-Lys-NH₂ | 5.519 |

(eg₂ = 11-Amino-3,6,9-Trioxaundecanoic Acid)

In table 1 DNA 3598 and DNA 3599 are test analytes used in examples 4, 5, 7, 8, and 9, S-DNA 3599 is a test “analyte” for direct immobilization onto the capture electrode used as a model system in examples 2, 3, and 6. PNA 3598 and PNA 3599 are test probes used in examples 4, 5, 7, 8, and 9 in conjunction with the complementary test analytes.

### Example 1

### Preparation of a Capture Electrodes Comprising Probe Molecules

The preparation procedure was conducted using two different protocols, using different setups. The two procedures are described below and are denoted S1 and S2, which also correspond to the setup used in the particular preparation.

Electrode Cleaning (S1)

Before immobilization of probe molecules onto the capture electrode material the electrodes were polished 1-2 minutes with 100 nm deagglomerated alpha alumina suspension on a wet polishing pad followed by polishing 1-2 minutes with 50 nm colloidal silica suspension on another wet polishing pad. After each polishing step the electrodes were sonicated in mQ water for a few minutes. Next, the electrodes were electropolished by cycling 24 times between 0.2 and 1.7 V vs. Ag/AgCl (saturated KCl) in 1M de-oxygenated H₂SO₄ followed by annealing where the potential were cycled 20 times between −0.1 and X V in the same solution. X was determined by adding the mean width (typically 50 mV) at half peak maximum to the average peak position of the sharp reductive peak around 920 mV (gold oxide reduction). Argon was purged through the solution throughout the procedure.

Electrode Cleaning (S2)

Before immobilization of probe molecules onto the capture electrode material the electrodes were rinsed in ethanol, rinsed in mQ water and submerged into a 100 mM solution of deoxygenated KOH. After 10 minutes, the electrodes were cycled 10 times between −0.3 V and 1.4 V vs. Ag/AgCl (1 M KCl) followed by keeping the potential at 0 V for 2 min. Argon was purged through the solution throughout the procedure.

Construction of Self-Assembled Monolayers on Capture Electrodes.

Solutions of adsorbate, i.e. solutions comprising probe-, linker and/or spacer molecules were prepared in Eppendorf tubes to a total volume of at least 30 μl. Clean electrodes were rinsed with mQ water and inserted face down into the tubes while making sure that the solutions cover the entire surface.

(S1): The tube was sealed with Parafilm during incubation and stored at room temperature. Electrodes modified with 6-mercaptohexan-1-ol were constructed by incubation in 1 mM 6-mercaptohexan-1-ol (MCH) for at least 1 hour followed by water rinse. Monolayers with thiolated DNA (e.g. S-DNA 3599) were obtained by incubation at least 30 minutes in an at least 10 μM solution of DNA in immobilization buffer: 1 M NaCl, 0.8 M PB pH 7.0, 5 mM MgCl₂ and 1 mM EDTA. After incubation the electrode was rinsed with immobilization buffer, 200 mM PB pH 7.0, 10 mM PB pH 7.0 and 10 mM PB with 10 mM EDTA to remove any remaining Mg²⁺. Before submersion into measuring solutions, the electrode was backfilled by 1 hour incubation in 1 mM MCH. PNA probe layers (e.g. comprising PNA 3598 and PNA 3599) were prepared by incubation for at least three hours with an aqueous solution of 10 μM probe and 10 μM MCH. The electrodes were then transferred to a solution of 100 μM MCH for 30-60 minutes to ensure complete coverage of the electrode. Finally, the electrodes were gently rinsed with water.

After measurements the working electrodes were removed from solution, tapped dry, hooded by placing them upside down in Eppendorf tubes, sealed with Parafilm and protected from light by wrapping in aluminum foil. Stored this way the electrodes showed no sign of monolayer decomposition after 3 weeks of storage. Still, to ensure a dense monolayer with few defects after storage, working electrodes were always backfilled by immersion into 1 mM MCH for 1 h before use. This was found to have negligible effect on the amount of e.g. DNA or probe on the electrodes.

(S2):

Electrodes modified with 6-mercaptohexan-1-ol were constructed by incubation in 0.1 mM 6-mercaptohexan-1-ol (MCH) for at least 4 hours followed by water rinse. Monolayers with thiolated DNA (e.g. S-DNA 3599) were obtained by incubation 5-10 s in a 10 μM solution of DNA in MQ. Before submersion into measuring solutions, the electrode was backfilled by 4 hour incubation in 0.1 mM MCH. PNA probe layers (e.g. comprising PNA 3598 and PNA 3599) were prepared by incubation with an aqueous solution of 5 μM probe and 50 μM MCH. The tube was sealed with Parafilm during incubation and stored at 28-31° C. for at least 36 h. After incubation, the electrodes were inserted directly into the measurement solution.

Cleanliness (all Examples)

Cleanliness was extremely important for the success of the experiments. All glassware was cleaned by boiling in 15% HNO₃ followed by rinsing in copious amounts of mQ water. To minimize contaminations, water was used directly from the purifier and glassware was handled through polyethylene gloves while wet.

### Example 2

### Effect of Measuring with Added Solvents Having a High Dielectric Constant

In the current and below examples the term “ratio” is used to describe the ratio between a given signal (e.g. current or charge transfer resistance (R_{ct})) in the presence/absence of a test analyte on the capture electrode. In examples 2 and 3 the test analyte comprises a piece of DNA, (S-DNA 3599), immobilized on the capture electrode, and is compared to an equivalent capture electrode with no DNA attached. The electrodes with/without immobilized DNA are described as positive/negative controls. The ratio is measure of the improvements in detection levels achievable and thus, this model system is ideal for testing solution effects on detection levels.

To examine the effect of the presence of solvents having high dielectric constants on the ratio between measurements on a positive and negative control, CV and DPV measurements were performed in solutions containing 0, 10, 50, 25, 90, 75 and 0% (vol) NMAA in that order with 200 μM K₃Fe(CN)₆, 200 μM K₄Fe(CN)₆ and 5 mM PB pH 8.0.

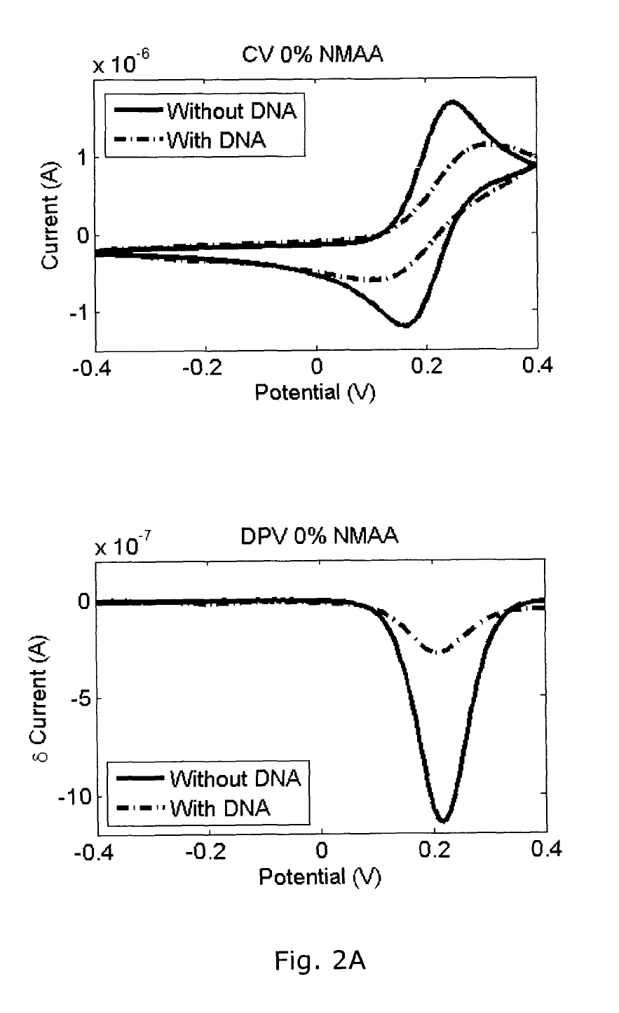

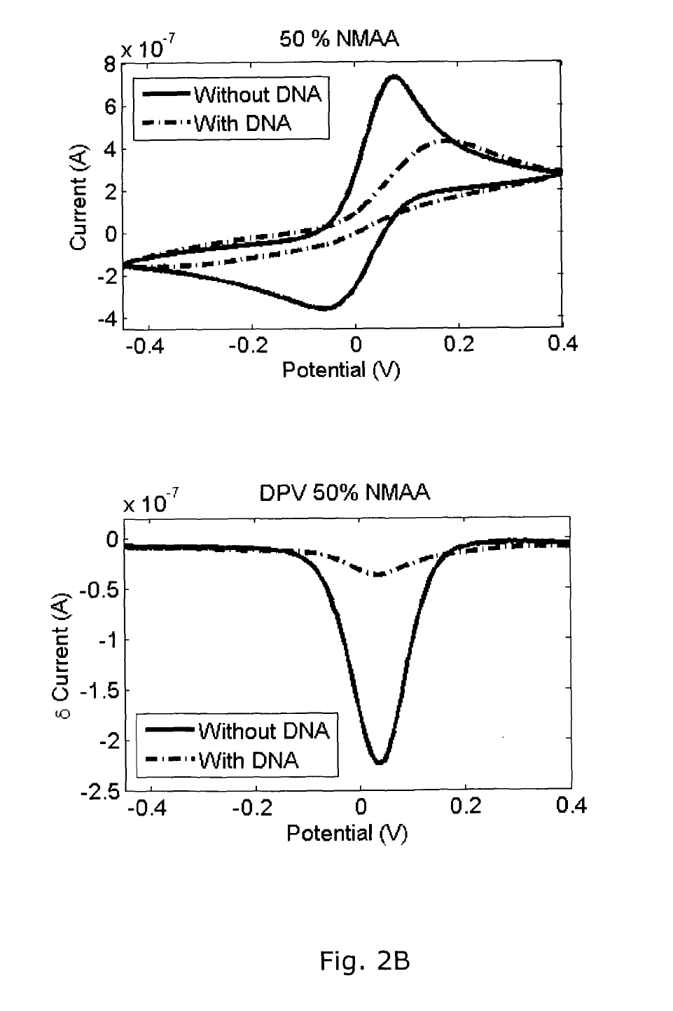

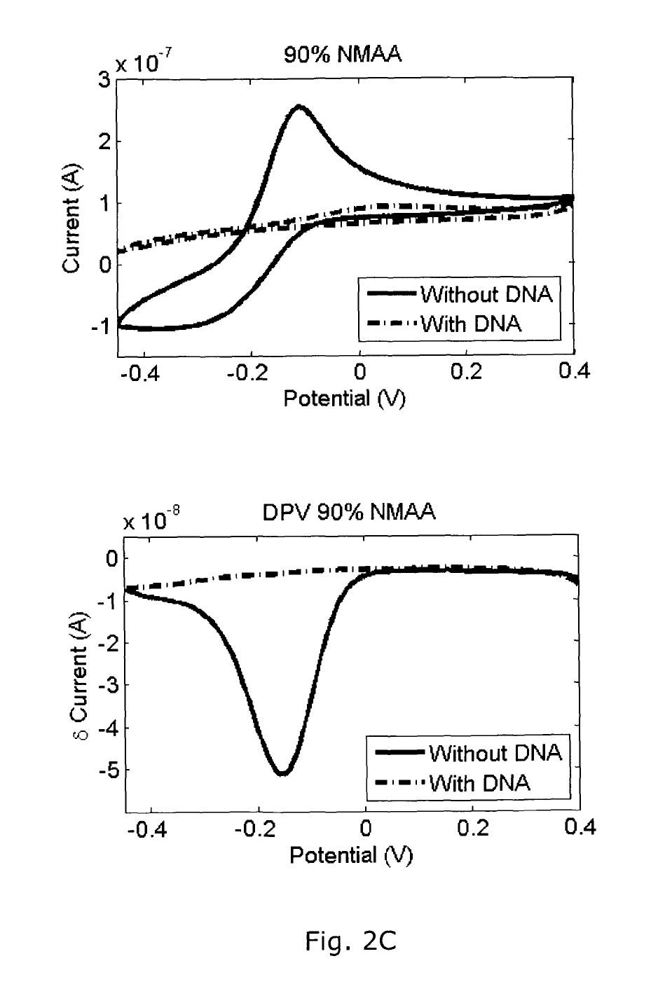

CVs shown in FIG. 2 reveal a smooth decrease in currents of both electrodes with increasing content of NMAA. The current of the DNA modified electrode is decreasing fastest with the signal almost completely gone at 90% NMAA. It is also noted that the reductive current is more greatly affected than the oxidative. Also evident from the plots is that the standard reduction potential decreases with increasing NMAA content. The signal reverses almost completely at the second measurement with 0% NMAA conducted as the last measurement in the series. Also the DPV measurements showed excellent systematics with all parameters varying smoothly with NMAA content and almost complete reversal at the second measurement without NMAA. The data is summarized in Table 2 below. Note again that higher content of NMAA increases the difference between the electrodes. It is also shown that the improvement is not smooth, but seems to be much greater at high NMAA content.

Table 2 shows key figures obtained from analysis of reductive DPV data with various contents of NMAA with 200 μM K₃Fe(CN)₆, 200 μM K₄Fe(CN)₆ and 5 mM PB pH 8.0. The peak position is the average between the peak position of the positive and negative control. The peak from the DNA-modified electrode in 90% NMAA was quantified using a manually set polynomial baseline.

TABLE 2
Effect of NMAA content in measuring solution on the change
in the electrical properties of test capture electrodes

| NMAA content | peak position | neg. control | pos. control | ratio |
|---|---|---|---|---|
| 0% (first) | 214 mV | −1.13 μA | −241 nA | 4.7 |
| 0% (second) | 216 mV | −1.01 μA | −145 nA | 6.9 |
| 10% | 181 mV | −696 nA | −145 nA | 4.8 |
| 25% | 128 mV | −521 nA | −78.9 nA | 6.6 |
| 50% | 35 mV | −217 nA | −28.8 nA | 7.6 |
| 75% | −86 mV | −72.6 nA | −1.90 nA | 38 |
| 90% | −162 mV | −46.2 nA | −154 pA | 300 |

### Example 3

### Effect of Measuring with Solutions Having a High pH

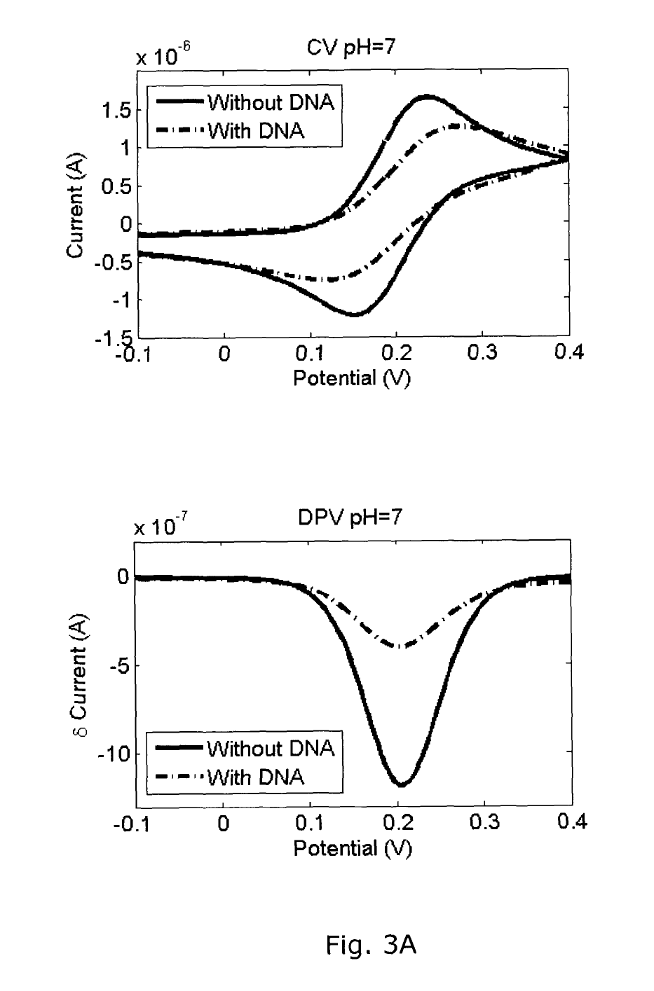

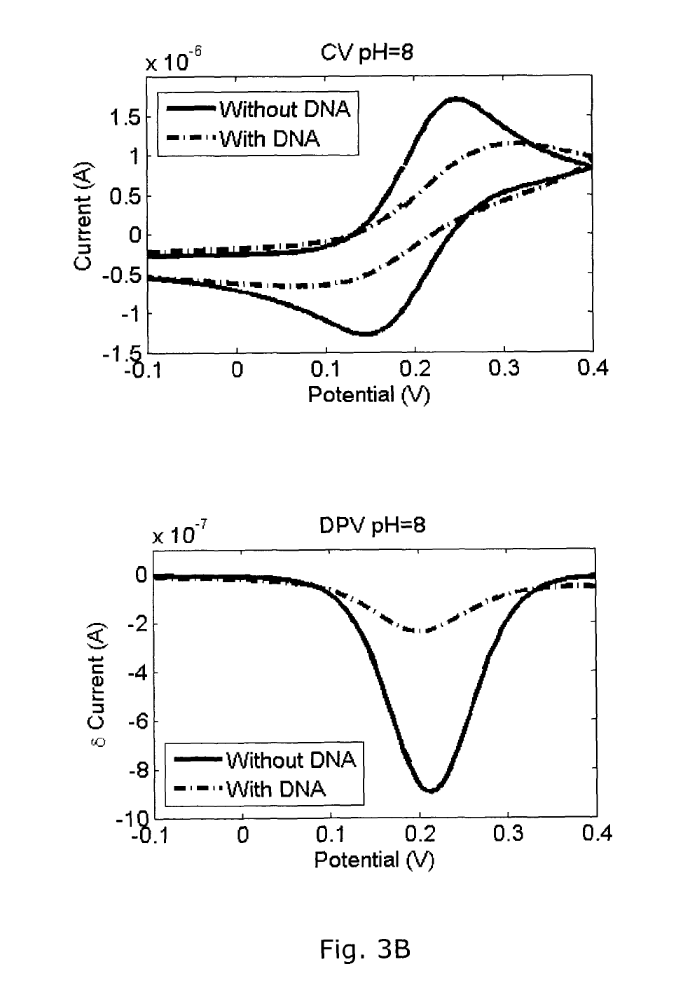

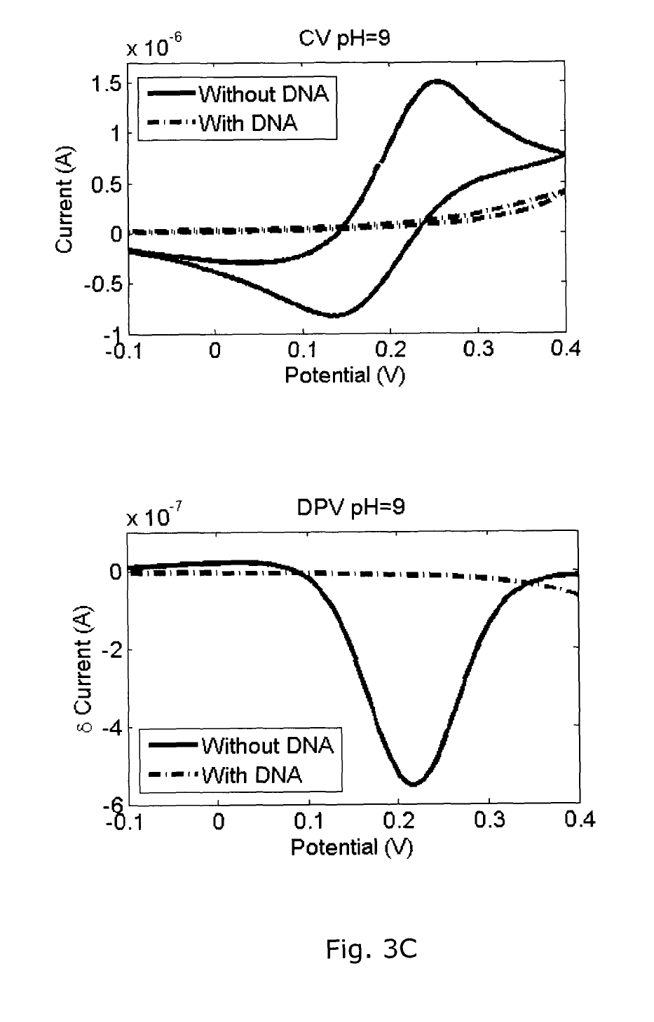

The buffer pH was varied in two experiments described below. In one experiment, measurements were conducted in measuring solutions containing 200 μM K₃Fe(CN)₆ and 200 μM K₄Fe(CN)₆ marker in 5 mM buffer at pH 6.0 (PB), 7.0 (PB), 8.0 (PB) and 9.0 (Tris-HCl). Selected resulting CV's are shown in FIG. 3. The CVs recorded at the different pH with the negative control electrode are very similar save for a slightly smaller current at pH 9.0. The hexacyanoferrate signal from the DNA modified positive control electrode on the other hand vanishes gradually as the pH increases.

Table 3 below shows peak heights obtained by peak analysis of DPV measurements recorded with 500 μM K₃Fe(CN)₆ and 500 μM K₄Fe(CN)₆ in 5 mM buffer with various pH. Due to the almost vanishing signal on the DNA-modified electrode at pH 9.0, the plot was analyzed by manually defining a polynomial baseline.

TABLE 3
Effect of measuring solution pH on the change in the electrical
properties of test capture electrodes (DPV)

| pH | Buffer | Neg. control | Pos. control | Ratio |
|---|---|---|---|---|
| 6.0 | PB | −1.27 μA | −0.64 μA | 2.0 |
| 7.0 | PB | −1.17 μA | −0.39 μA | 3.0 |
| 8.0 | PB | −880 nA | −200 nA | 4.4 |
| 9.0 | Tris-HCl | −548 nA | −1.3 nA | 420 |

Contrary to the data from CV, the DPV data show a gradual decrease in signal with increasing pH on the electrode without DNA. However, as evident from Table 3, the height of the peak from the DNA modified electrode decreases even faster resulting in an increasing ratio of peak heights with pH. It is notable that the measurement at pH 9.0 is surprisingly two orders of magnitude better than at pH 8.0. A reason for this might have been that the buffer used was a tris-HCl buffer rather than PB utilized in the other cases. This hypothesis was tested and no effect of the buffer change was seen, i.e. the improved ratio was also present for PB buffer.

In agreement with the decreasing signal in the DPV data, analysis of EIS data from the electrode without DNA modified cation show a gradual increase in R_{ct} with pH. The ratio of R_{ct} does, however, not vary monotonically with pH, but still exhibits the unexpected large improvement at pH 9.0 compared to pH 6.0, 7.0 and 8.0 (see Table 4). Another set of experiments was conducted in 1 mM tris-HCl buffer at pH 7.4, 8.4 and 9.0. This set of measurements showed the same tendencies as the one described above, but with the CVs recorded with the negative control being virtually indistinguishable and the improvements in R_{ct} ratio being smoother than was the case above. The numbers in the latter case are 87, 189 and 393 at pH 7.4, 8.4 and 9.0 respectively with uncertainties in the fit being 7, 10 and 20° k. The reason for the smoother transition may have to do with the altered distribution in pH.

Table 4 thus shows R_{ct} obtained by analysis of EIS data recorded with 500 μM K₃Fe(CN)₆ and 500 μM K₄Fe(CN)₆ in 5 mM buffer with various pH. Because of the large R_{ct} of the DNA-modified electrode at pH 9.0, the data was fitted to a circuit lacking Warburg impedance. For obtaining charge transfer resistances, the EIS data is fitted to a modified Randles circuit as the equivalent circuit. In this circuit, the impedance from double layer charging is connected in parallel with the impedance of charge transfer that contains a resister, R_{ct}, to account for the charge transfer resistance and a generalized Warburg impedance to account for the diffusion. Unaccounted resistance of the system is modeled by a solution resistance, which is connected in serial to the above. Constant phase elements are used to account for the impedance from double layer charging and diffusion effects.

TABLE 4
Effect of measuring solution pH on the change in the electrical
properties of test capture electrodes (EIS)

| | | | | | Uncertainty |
|---|---|---|---|---|---|
| pH | Buffer | Neg. control | Pos. control | Ratio | in fittings |
| 6.0 | PB | 1.9 kΩ | 18.0 kΩ | 9.5 | 4% |
| 7.0 | PB | 3.6 kΩ | 41.0 kΩ | 11.3 | 10% |
| 8.0 | PB | 11.8 kΩ | 80.0 kΩ | 6.7 | 3% |
| 9.0 | Tris-HCl | 19.9 kΩ | 1.8 MΩ | 91.0 | 2% |

### Example 4

### Formation of Probe-Analyte Complex and Detection of Analyte

Two sensors comprising capture electrodes with different probe sequence were prepared to examine if the response to DNA hybridization corresponds to the differences described in the previous examples where test capture electrodes were used. The electrodes were modified with probes PNA 3598 and PNA 3599 by 3 hour incubation in 10 μM PNA with 10 μM MCH followed by a 30 min incubation in 100 μM MCH. Before immersion into the reference solution the electrodes were rinsed briefly with water.

Generally, hybridization of probe molecules with analyte was carried out by incubation of the capture electrode in a sample solution at 37° C. for 30 minutes in 200 mM PB pH 7.0 with 400 mM K₂SO₄ as described in S. D. Kieghley et al., Biosensors & Bioelectronics 2008, 24 (4), 906-911. Before incubation all solutions were heated on a heating block at 92° C. for at least five minutes and cooled on ice for at least ten minutes before the liquid was spun down and kept on ice until use. The electrodes were placed face-down in a low-stick shallow bottomed Eppendorf tube containing between 40 and 150 μl sample solution. The tube was then sealed with several layers of Parafilm to avoid evaporation during incubation. After incubation, the electrodes were rinsed gently with hybridization buffer, 10 mM tris-HCl pH 7.4 with 5 mM NaCl and transferred directly to the measuring solution.

A series of measurements in a measuring solution were conducted on the capture electrodes before and after 30 min incubation with 500 nM DNA complementary to PNA 3598. CV and DPV were performed in aqueous solutions containing 5 μM Ru(NH₃)₆Cl₃ and 1 mM K₃Fe(CN)₆. All measuring solutions were buffered with 1 mM Tris-HCl buffer pH 8.4. According to prior experiments, addition of Ru(NH₃)₆Cl₃ is non-destructive for the interactions between Fe(CN)₆³⁻ and the probe layer.

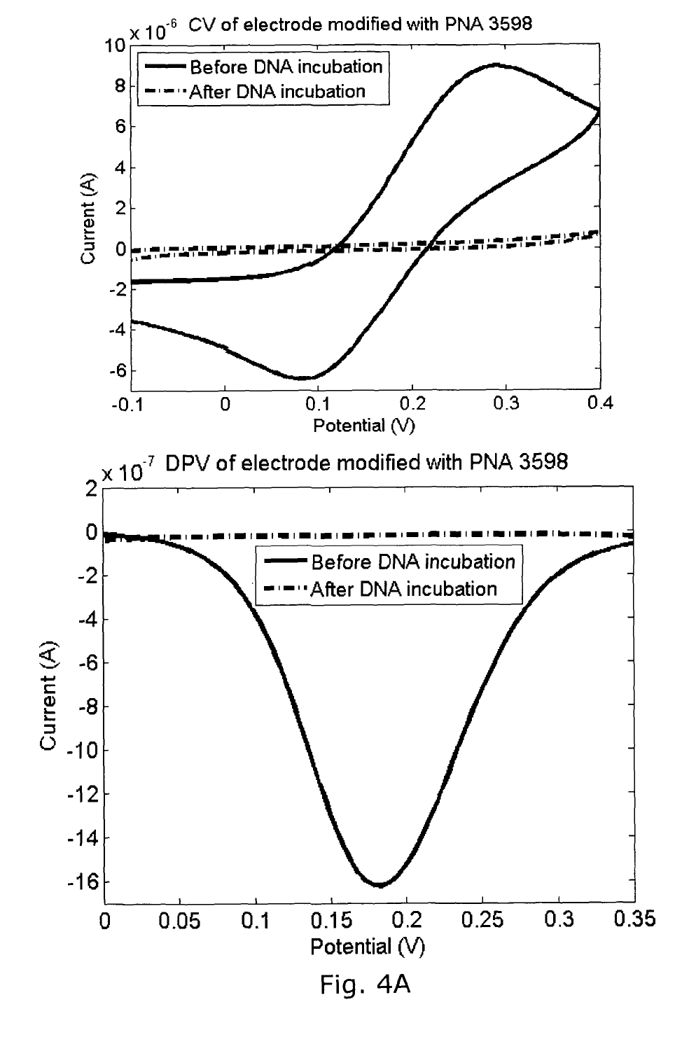

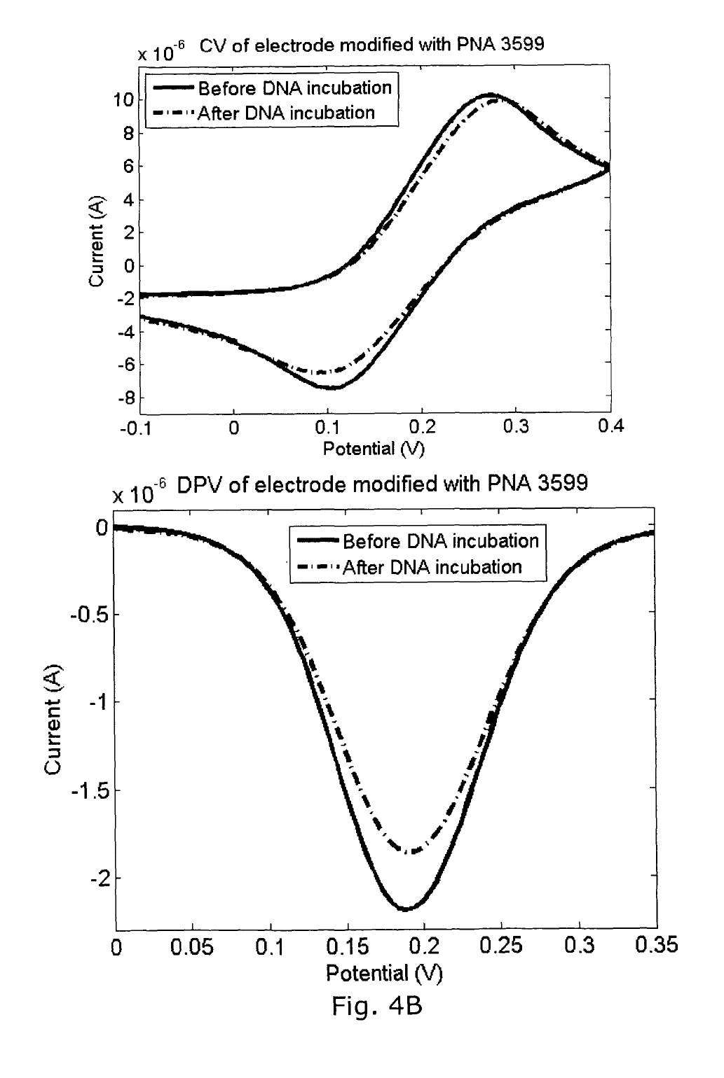

The signal alteration detected when contacting with complementary analyte, and thus the ratio of the measured currents, was very large. The CVs recorded with the electrode modified with PNA 3599 had only slightly smaller currents from Fe(CN)₆^{3-/4-} with a quenching of 4% and 13% for the oxidative and reductive peak current respectively after DNA incubation. The electrode modified with PNA 3598, on the other hand, show an apparently complete quenching of the currents from Fe(CN)₆^{3-/4-}. The CVs are shown in FIG. 4.

The DPVs also reflect this behavior. The peak current from the electrode modified with PNA 3599 declines 15% while that from the electrode modified with PNA 3598 decline 99.93% compared to the value before incubation. The latter corresponds to a ratio of 1450.

### Example 5

### Effect of Contacting with Organic Solvents Prior to Measuring

The measurement described in example 4 (i.e. using 500 nM 3598 DNA complementary to PNA 3598) was first repeated after 45 minutes in measuring solution. A decline of all currents around 5% was noticed, but the signals were otherwise intact. Next, the electrodes were subject to 5 s rinse with ethanol, tetrahydrofurane and acetonitrile in that order. After each rinse with an organic solvent, the electrodes were flushed with water and characterized by reductive DPV in the measuring solution described in example 4. The time elapsed between the measurements were 34, 35 and 12 minutes respectively. Table 5 shows the result.

TABLE 5
Effect of organic solvent rinses on the change in the
electrical properties of a capture electrode comprising
a PNA 3598 and 3599 probe, with a DNA 3598 analyte.

| | Peak current PNA | Peak current PNA | |
|---|---|---|---|
| Measurement | 3599 Probe | 3598 probe | Ratio |
| First | −1849 nA | −2 nA | 1227 |
| 45 min | −1787 nA | −5 nA | 386 |
| EtOH rinse | −1512 nA | −4 nA | 344 |
| THF rinse | −1083 nA | −5 nA | 220 |
| MeCN rinse | −947 nA | −3 nA | 338 |

It is noted that both the current from the capture electrode comprising the PNA 3598 probe and the current from the capture electrode comprising the PNA 3599 probe decrease monotonically with time while the current from reduction of ferricyanide with the capture electrode comprising the PNA 3598 probe stays within −5 nA. The conclusion drawn is therefore that rinsing with the above organic solvents is not fatal for hybridization, and they are thus suitable for use in rinsing steps where non-specific analytes are removed, which would not be removed with aqueous solutions not comprising organic solvents.

### Example 6

### Effect of Measuring with Solutions Having a High pH and with Added Solvents Having a High Dielectric Constant

In example 6 the materials, methods and preparations denoted S2 was used. In example 6 the test analyte comprises a piece of DNA, (S-DNA 3599), immobilized on the capture electrode, and is compared to an equivalent capture electrode with no DNA attached. The electrodes with/without immobilized DNA are described as positive/negative controls. The ratio is measure of the improvements in detection levels achievable and thus, this model system is ideal for testing solution effects on detection levels. The two positive controls have been immobilised with two different amounts of DNA, by incubating in the S-DNA 3599 solution for 5 s and 10 s respectively.

To examine the effect having a high pH and with added solvents having a high dielectric constant on the ratio between measurements on a positive and negative control, DPV measurements were performed in solutions containing 90% NMAA, 200 μM K₃Fe(CN)₆, 200 μM K₄Fe(CN)₆ and 5 mM buffer pH 8.0 (Tris-HCl), pH 8.4 (Tris-HCl), pH 9.0 (Tris-HCl), pH 9.5 (Tris-HCl), pH 8.0 (Tris-HCL) in that order.

The DPV measurements showed excellent systematics with all parameters varying smoothly with pH content and almost complete reversal at the second measurement at pH 8.0. The data is summarized in Table 6 below. Note again that higher pH increases the difference between the electrodes.

Table 6 shows key figures obtained from analysis of reductive DPV data with various solution pH in 90% NMAA with 200 μM K₃Fe(CN)₆, 200 μM K₄Fe(CN)₆ and 5 mM Tris-HCl. The positive controls were incubated with two different amounts of DNA.

TABLE 6
Effect of pH in 90% NMAA content in measuring solution on the
change in the electrical properties of test capture electrodes

| pH | neg. control | pos. control | ratio | pos. control | ratio |
|---|---|---|---|---|---|
| 8.0 | −269 nA | 13.2 nA | 19.9 | −37.4 nA | 7.03 |
| 8.4 | −225 nA | 10.3 nA | 21.8 | −24.4 nA | 9.22 |
| 9.0 | −178 nA | 7.84 nA | 22.7 | −17.2 nA | 10.3 |
| 9.5 | −176 nA | 5.79 nA | 30.4 | −13.2 nA | 13.3 |
| 8.0 | −341 nA | 21.5 nA | 15.9 | −4.10 nA | 8.32 |

### Example 7

### Effect on Sensor of Measuring with Solutions Having a High pH and Measuring with Added Solvent with a High Dielectric Constant

In examples 7 and 8 the materials, methods and preparations denoted S2 was used.

In examples 7 and 8 the test analyte comprises a piece of DNA, (DNA 3599), hybridized to an immobilized PNA probe (PNA 3599) and is compared to an equivalent capture electrode with no DNA hybridized to a similar PNA probe (PNA 3599). The electrodes with/without DNA are described as positive/negative electrodes. The ratio is measure of the improvements in detection levels achievable and thus, this system is ideal for testing solution effects on detection levels.

Positive and negative electrodes were prepared using PNA 3599.

In examples 7 SWVs of the positive and negative electrodes were initially measured in a solution of 100 μM K₃Fe(CN)₆, 100 μM K₄Fe(CN)₆ and 1 mM Tris-HCL pH 7.4. Directly following the measurements, electrodes were incubated 30 minutes in a hybridization solution containing 5 mM Tris-HCL pH 8.0, 90% NMAA, and either 10 nM or 100 nM DNA 3599 (positive electrodes) or no DNA (negative electrode). Care was taken to keep the DNA-free negative electrode free from contaminations with DNA from the positive electrodes.

Before incubation all DNA solutions were heated on a heating block at 92° C. for at least five minutes and cooled on ice for at least ten minutes before the liquid was spun down and kept on ice until use. The electrodes were placed face-down in a low-stick shallow bottomed Eppendorf tube containing 30 μl sample solution. The tube was then sealed with several layers of Parafilm to avoid evaporation during incubation.

To examine the effect of varying the pH of the measurement solution, SWVs of positive and negative electrodes were measured in measuring solutions containing 100 μM K₃Fe(CN)₆ and 100 μM K₄Fe(CN)₆ marker in 1 mM buffer at pH 7.4 (Tris-HCl), 8.6 (Tris-HCl), 9.5 (CAPSO), and 10.5 (CAPSO). Subsequently SWVs of positive and negative electrodes were measured in measuring solutions containing 500 μM K₃Fe(CN)₆ and 500 μM K₄Fe(CN)₆ marker in 1 mM buffer at pH 10.5 (CAPSO) in first 0% MNAA, then 90% NMAA. Prior to each measurement at a new pH, the electrodes were incubated 10 minutes in a solution of degassed 100 mM buffer of the type and pH corresponding to the subsequent measurement. The solution was kept dark and purged with argon throughout the incubation. This achieved a quick setting of the electrodes to the changed pH.

Table 7 below shows peak heights obtained by peak analysis of SWV measurements recorded with 100 μM K₃Fe(CN)₆ and 100 μM K₄Fe(CN)₆ in 1 mM buffer with various pH. b and a denotes measurements in pH 7.4 before and after DNA incubation. 10.5-5 was recorded in 500 μM K₃Fe(CN)₆ and 500 μM K₄Fe(CN)₆ in 1 mM CAPSO pH 10.5. 10.5-5N was recorded in 500 μM K₃Fe(CN)₆ and 500 μM K₄Fe(CN)₆ in 1 mM CAPSO pH 10.5 and 90% NMAA.

TABLE 7
Effect of measuring solution pH and NMAA content on the change in
the electrical properties of sensor capture electrodes (SWV). The
ratios are peak heights of the negative electrode (0 nM DNA) devided
by the peak height of the positive electrode. The bottom two experiments
compare measuring without and with 90% NMAA.

| | | 0 nM DNA | 10 nM DNA | | 100 nM DNA | |
|---|---|---|---|---|---|---|
| | | Peak | Peak | | Peak | |
| pH | Buffer | height | height | Ratio | height | Ratio |
| 7.4b | Tris-HCl | 2896 nA | 2896 nA | 1.00 | 3074 nA | 0.94 |
| 7.4a | Tris-HCl | 3154 nA | 2948 nA | 1.07 | 2992 nA | 1.05 |
| 8.6 | Tris-HCl | 2483 nA | 2335 nA | 1.06 | 1518 nA | 1.64 |
| 9.5 | CAPSO | 2300 nA | 1468 nA | 1.57 | 504 nA | 4.56 |
| 10.5 | CAPSO | 2419 nA | 1021 nA | 2.37 | 429 nA | 5.64 |
| 10.5-5 | CAPSO | 7351 nA | 2887 nA | 2.55 | 1792 nA | 4.10 |
| 10.5-5N | CAPSO | 164 nA | 47.9 nA | 3.42 | 14.5 nA | 11.3 |

As with the model system in example 3, the SWV data show a gradual decrease in signal with increasing pH on all electrodes. However, as evident from Table 6, the height of the peak from the positive electrodes decreases much faster than the height of the peak from the negative electrode resulting in an increasing ratio of peak heights with pH. The electrode with highest DNA content decreases more than the one with lower DNA content. Other experiments have established that varying the buffers used does not influence the ratios.

The last two measurements show that increasing marker concentration decreases the ratio, and that adding 90% NMAA to the measuring solution greatly increases the ratio.

### Example 8

### Effect of Contacting with Organic Solvents Prior to Measuring (2)

The measurements as described in example 4 are repeated but with inclusion of rinsing steps comprising the use of organic solvents, such as tetrahydrofurane (THF), acetonitrile, and ethanol and certain combinations thereof, inbetween the contact with the sample solution and the immersion into the measuring solution.

For this example the sample solution is prepared with a contaminant, e.g. non-complementary nucleic acids or traces of cell debris.

The experiments show that the signal-to-background ratio is generally improved when rinsing with organic solvents, and it is improved more than when using hybridization buffer as in example 4. The same effect is seen when using this method at higher pH values for the measuring solution, and in combination with the presence of e.g. NMAA in the measuring solution.

### Example 9

### Measuring the Effect of Charge Compensation on a bioFET

A bioFET is constructed with a PNA probe and used to measure changes in current and resistance caused by binding of a complementary DNA strand. Further details of the overall experimental procedure may be found in Uno et al. The I-V characteristics reveal that the PNA-DNA duplexes induce a positive shift in the threshold voltage, V_{T}, and a decrease in the saturated drain current, I_{D}. The effect of using NMAA and high pH in the measuring solution is determined to increase the changes in threshold voltage and saturated drain current significantly.

The bioFET consists of a p-type silicon substrate with two n-doped regions (source and drain), which are separated by a short channel covered by the gate insulator. The gate insulator is a double layer of SiO₂—Si₃N₄, and each layer is 100 nm thick. The length of the gate region is between 10 and 300 μm, and the width is fixed at 200 μm.

PNA 3598 is immobilized on a silicon nitride gate insulator by an addition reaction between a maleimide group introduced on the gate surface, the succinimide group of N-(6-maleimidocaproyloxy)succinimide, and the thiol group of the terminal cysteine in PNA. The maleimide group on the surface is introduced by an APTES reaction with the SiO₂ surface followed by a reaction with N-(6-maleimidocaproyloxy)sulfosuccinimide under appropriate conditions.

I-V characteristics are measured between source and drain using standard electrical measuring equipment and used as reference.

The bioFET is then immersed in a hybridisation solution containing 100 nM DNA 3598 for 30 minutes. The bioFET is washed in hybridisation solution and immersed in a measuring solution of 1 mM Tris-HCl buffer pH 7.4 and I-V characteristics are measured. The measuring solution is changed throughout a series of measurements to buffered solutions and increasing pH and NMAA concentrations. The shift in threshold voltage and decrease in saturation drain current compared to the reference measurement are seen to increase in amplitude significantly with the increase in pH, as well as with the increase in NMAA concentration.

### REFERENCES

de-los-Santos-Alvarez et al., Anal. Bloanal. Chem. 2004, 378, 104-118
WO2010/025547
WO2009/122159
Li et al., Anal. Chem. 2010, 82, 1166-1169
Chemical Rubber Company: Handbook of Physics and Chemistry
S. D. Kieghley et al., Biosensors & Bioelectronics 2008, 24 (4), 906-911
Peptide Nucleic Acids, (Editor: Peter E. Nielsen), Horizon Bioscience, 2^{nd} edition 2004
Uno et al., Anal. Chem. 2007, 79, 52-59

1. A method of detecting an analyte comprising,
providing a capture electrode comprising probe molecules at the surface thereof, wherein the probe molecules are designed to specifically bind to said analyte,
contacting the capture electrode with a sample solution, such that said analyte in the solution forms a probe-analyte complex at the surface of said capture electrode,
measuring the electrical properties of the capture electrode after contact with said sample solution, wherein changes in said electrical properties are indicative of the formation of the probe-analyte complex at the electrode surface.

2. The method according to claim 1, wherein the measuring of the electrical properties of the capture electrode after contact with said sample solution is performed in a measuring solution having a pH value of at least pH 7.5.

3. The method according to claim 1, wherein said measuring solution has a pH value of at least pH 8.8.

4. The method according to claim 1, wherein the measuring of the electrical properties of the capture electrode after contact with said sample solution is performed in a measuring solution comprising at least one non-aqueous solvent having a dielectric constant higher than 80 at 30° C.

5. The method according to claim 4, wherein said non-aqueous solvent is selected from the group consisting of N-methylformamide, N-methylacetamide, N-methylpropanamide, N-ethylacetamide and N-propylpropanamide.

6. The method according to claim 4, wherein the amount of said non-aqueous solvent is at least 10% (v/v).

7. The method according to claim 1, wherein the capture electrode is contacted with a solution comprising least one organic solvent prior to the measuring of the electrical properties of the capture electrode.

8. The method according to claim 1, wherein the changes in electrical properties are indicated as a ratio between a reference signal and the signal measured after contact with the sample solution.

9. The method according to claim 8, wherein the reference signal is the electrical properties as measured in a reference solution or the reference signal is the electrical properties of a reference capture electrode not comprising any probe molecules.

10. The method according to claim 1, wherein the measuring solution comprises one or more redox active molecules in solution.

11. The method according to claim 10, wherein the redox active molecules are salts of metal complexes selected from the group consisting of [Fe(CN)6]3−, [Fe(CN)6]4−, [Ru(CN)6]3−, [Ru(CN)6]4−, [Mn(CN)6]3−, [Mn(CN)6]4−, [W(CN)8]3−, [W(CN)8]4−, [Os(CN)6]3−, [Os(CN)6]4−, [Mo(CN)8]3−, [Mo(CN)8]4−, [Cr(CN)6]3−, [Co(CN)6]3−, [PtCl6]2−, [SbCl6]3−, [RhCl6]3− and [IrCl6]2−.

12. The method according to claim 1, wherein the probe molecules are electrically un-charged and the analyte is charged.

13. The method according to claim 1, wherein the probe molecules are selected from the group consisting of small molecules, proteins, peptides, nucleic acids and nucleic acid analogous.

14. The method according to claim 1, wherein the probe is a peptide nucleic acid (PNA) and the analyte is a de-oxy ribonucleic acid (DNA) or ribonucleic acids (RNA).

15-17. (canceled)

18. The method according to claim 4, wherein the amount of said non-aqueous solvent is at least 50% (v/v).

19. The method according to claim 4, wherein the amount of said non-aqueous solvent is at least 90% (v/v).
